(19) United States
(12) Patent Application Publication
(10) Pub. No.: US 2008/0225525 A1
(43) Pub. Date: Sep. 18, 2008

(54) LIGHT SOURCE MODULE

(75) Inventors: Shen-Huei Wang, Hsinchu (TW); Chien-Chiu Hsueh, Hsinchu (TW); Nien-Hui Hsu, Hsinchu (TW); Chien-Chung Huang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/838,897

(22) Filed: Aug. 15, 2007

(30) Foreign Application Priority Data
Mar. 13, 2007 (TW) 96108541

(51) Int. Cl. F21V 29/02

(52) U.S. Cl. 362/294

(57) ABSTRACT

A light source module for a projection apparatus including a light source unit, a fan, a temperature sensor and a temperature controller is provided. The fan is disposed towards the light source unit and is capable of cooling the light source unit. The temperature sensor is disposed adjacent to the light source unit and is capable of sensing an operating temperature of the light source unit. The temperature controller is electrically coupled to the fan and the temperature sensor, and is capable of adjusting a rotation speed of the fan according to the operating temperature of the light source unit. The invention is capable of keeping the operating temperature of the light source unit at or close to the predetermined operating temperature thereof by adjusting the rotation speed of the fan.

### CROSS-REFERENCE TO RELATED APPLICATION

This application claims the priority benefit of Taiwan application serial no. 96108541, filed Mar. 13, 2007. All disclosure of the Taiwan application is incorporated herein by reference.

### BACKGROUND OF THE INVENTION

1. Field of the Invention

The present invention generally relates to a light source module, and more particularly, to a light source module having a temperature controller.

2. Description of Related Art

As science and technology develop, demand of projection apparatus for higher brightness are increasing. As a result, the wattage of light bulb used in the projection apparatus is increased and the operating temperature of the light bulb is higher. However, in order to control the operating temperature of the light bulb within the range set by the manufacturer to maintain characteristics and life span of the light bulb, the cooling system of the light bulb is very important.

In a conventional projection apparatus, a blower is normally disposed close to the light source. The blower is capable of generating a cooling airflow towards the lampwick of the light bulb for cooling the lampwick. However, the rotation speed of the blower is normally set according to the wattage of the light bulb. Therefore, in practice, the blower cannot accurately maintain the operating temperature of the light bulb within the recommended range set by the manufacturer to maintain the life span.

To maintain the operating temperature of a conventional projection apparatus, the projection apparatus also has a cooling system. The conventional cooling system has a temperature sensor and a temperature controller disposed within the projection apparatus. The temperature sensor of the conventional cooling system is used for sensing the environmental temperature inside the projection apparatus and the temperature controller is used for controlling the rotation speed of a cooling fan according to the environmental temperature inside the projection apparatus.

Because the temperature sensor is far away the light bulb, it is difficult to control the operating temperature of the light bulb within the manufacturer recommended range by adjusting the rotation speed of the fan according to the environmental temperature. Consequently, the light bulb of the conventional projection apparatus has a shorter life span.

### SUMMARY OF THE INVENTION

Accordingly, the present invention is directed to a light source module capable of controlling the operating temperature of a light source unit closer to an ideal operating temperature so as to optimize the brightness and life span of the light source unit.

According to an embodiment of the present invention, a light source module for a projection apparatus is provided. The light source module includes a light source unit, a fan, a temperature sensor and a temperature controller. The fan is disposed towards the light source unit and is capable of cooling the light source unit. The temperature sensor is disposed adjacent to the light source unit and is capable of sensing an operating temperature of the light source unit. The temperature controller is electrically coupled to the fan and the temperature sensor, and is capable of adjusting a rotation speed of the fan according to the operating temperature of the light source unit.

According to the embodiment of the present invention, the light source unit includes a light source reflector and a lampwick. The lampwick is disposed inside the light source reflector.

According to the embodiment of the present invention, the fan is disposed towards the lampwick and is capable of cooling the lampwick.

According to the embodiment of the present invention, the temperature sensor is a thermal couple disposed on the light source reflector for sensing a temperature of the light source reflector or disposed on the lampwick for sensing a temperature of the lampwick.

According to the embodiment of the present invention, the temperature sensor is an infrared sensor disposed towards the light source reflector for sensing a temperature of the light source reflector or disposed towards the lampwick for sensing a temperature of the lampwick.

According to the embodiment of the present invention, the temperature controller has a storage unit. The storage unit is capable of saving a predetermined temperature of the light source unit.

According to the embodiment of the present invention, the predetermined temperatures is an ideal operating temperature of the lampwick.

According to the embodiment of the present invention, the predetermined temperature is an ideal operating temperature of the light source reflector when the lampwick is operating at an ideal operating temperature of the lampwick.

According to the embodiment of the present invention, the temperature controller also has a decision module. Furthermore, the decision module is capable of comparing the operating temperature with the predetermined temperature and adjusting the rotation speed of the fan accordingly.

According to the embodiment of the present invention, the temperature controller increases the rotation speed of the fan when the decision module determines that the operating temperature is higher than the predetermined temperature. Conversely, the temperature controller decreases the rotation speed of the fan when the decision module determines that the operating temperature is lower than the predetermined temperature.

According to the embodiment of the present invention, the fan includes an axial fan or a blower.

According to the embodiment of the present invention, the temperature controller also has a voltage control unit. The voltage control unit is capable of adjusting a voltage driving the fan to adjust the rotation speed of the fan.

The light source module of the present invention has a temperature controller. Therefore, the present invention is capable of controlling the operating temperature of the light source unit closer to the ideal operating temperature by adjusting the rotation speed of the fan and consequently optimizing both the brightness and the life span of the light source unit.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a light source module according to an embodiment of the present invention.

FIG. 2 is a flow chart of a temperature controller shown in FIG. 1.

FIG. 3 is a diagram of a light source module according to another embodiment of the present invention.

### DESCRIPTION OF THE EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “coupled” and variations thereof herein are used broadly and encompass direct and indirect connections, couplings, and mountings. Similarly, the terms “adjacent to” and variations thereof herein are used broadly and encompass directly and indirectly “adjacent to”. Therefore, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

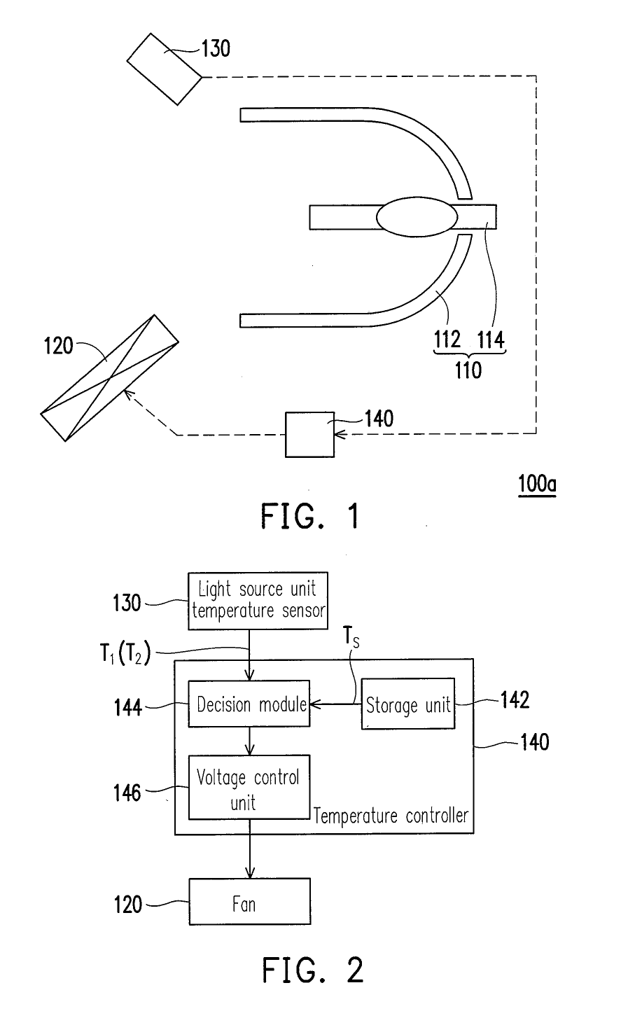

FIG. 1 is a diagram of a light source module according to an embodiment of the present invention. FIG. 2 is a flow chart of a temperature controller shown in FIG. 1. As shown in FIGS. 1 and 2, the light source module 100a is adapted to a projection apparatus (not shown), for example, a projector. The light source module 110a includes a light source unit 110, a fan 120, a temperature sensor 130 and a temperature controller 140. The fan 120 is disposed towards the light source unit 110 and is capable of cooling the light source unit 110. The temperature sensor 130 is disposed adjacent to the light source unit 110 and is capable of sensing an operating temperature of the light source unit 110. The temperature controller 140 is electrically coupled to the fan 120 and the temperature sensor 130 and is capable of adjusting a rotation speed of the fan 120 according to the operating temperature.

In the present embodiment, the light source unit 110 includes a light source reflector 112 and a lampwick 114. The lampwick is disposed inside the light source reflector 112. The operating temperature of the light source reflector 112 is T₂ and the operating temperature of the lampwick 114 is T₁, for example. Furthermore, the fan 120 is a blower disposed towards the lampwick 114 for cooling the lampwick 114, for example. In addition, the temperature sensor 130 is, for example, an infrared sensor disposed towards the lampwick 114 for sensing the operating temperature T₁ of the lampwick 114. The temperature controller 140 is capable of saving a predetermined temperature Tₛ. The predetermined temperature Tₛ is an ideal operating temperature of the lampwick 114 provided by a manufacturer, for example.

When the projection apparatus is activated, the operating temperature T₁ of the lampwick 114 increases due to the consumption of electrical energy. The operating temperature T₂ of the light source reflector 112 also increases by reflecting the light from the lampwick 114. Because the fan 120 is disposed towards the lampwick, the cooling airflow produced by the rotating fan 120 cools down the light source reflector 112 and the lampwick 114. At this time, the temperature sensor 130 (the infrared sensor) disposed towards the lampwick 114 is able to sense the operating temperature T₁ of the lampwick 114 and transmit the operating temperature T₁ of the lampwick 114 to the temperature controller 140. The temperature controller 140 compares the operating temperature T₁ of the lampwick 114 with the predetermined temperature Tₛ so as to adjust the rotation speed of the fan 120.

More specifically, the temperature controller 140 has a storage unit 142, a decision module 144 and a voltage control unit 146. The storage unit 142 is capable of saving the predetermined temperature Tₛ of the light source unit 110. The decision module 144 is capable of comparing the operating temperature T₁ of the lampwick 114 with the predetermined temperature Tₛ to adjust the rotation speed of the fan 120. The voltage control unit 146 is capable of adjusting the voltage of a power source (not shown) of the projection apparatus that drives the fan 120 so as to adjust the rotation speed of the fan 120. When the decision module 144 determines that the operating temperature T₁ is higher than the predetermined temperature Tₛ, the voltage control unit 146 increases the voltage of the power source driving the fan 120 so as to increase the rotation speed of the fan 120. This prevents the light source unit 110 from reaching too high temperature that adversely affects the life span of the light source unit 110. Conversely, when the decision module 144 determines that the operating temperature T₁ is lower than the predetermined temperature Tₛ, the voltage control unit 146 decreases the voltage of the power source driving the fan 120 so as to decrease the rotation speed or stop the fan 120. As a result, the light source unit 110 is prevented from reaching too low temperature that adversely affects the brightness of the light source unit 110. Therefore, the present invention is able to control the operating temperature of the light source unit closer to an ideal operating temperature of the light source unit and optimize the brightness and the life span of the light source unit at the same time.

It should be noted that the present invention is not limited to this embodiment. For example, the fan 120 is an axial fan and the temperature sensor 130 (the infrared sensor) is disposed towards the light source reflector 112 for sensing the operating temperature T₂ of the light source reflector 112. However, the predetermined temperature Tₛ is an ideal operating temperature of the light source reflector 112 when the lampwick 114 is operating at an ideal operating temperature of the lampwick.

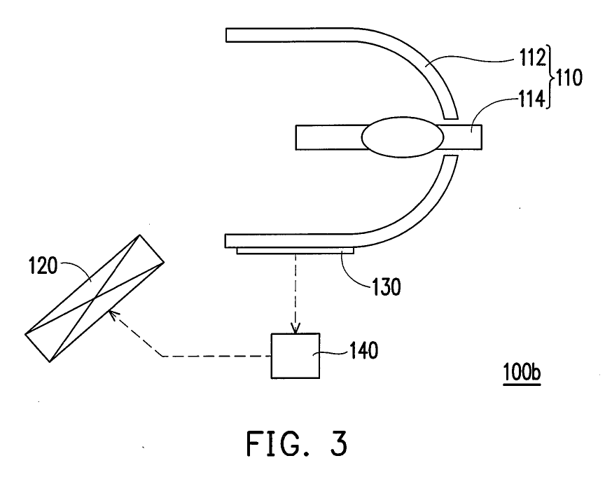

FIG. 3 is a diagram of a light source module according to another embodiment of the present invention. As shown in FIG. 3, the light source module 100b is similar to the light source module 100a in FIG. 1. The main difference between the two is that the temperature sensor 130 is a thermal couple. Furthermore, the temperature sensor 130 (the thermal couple) is disposed on the light source reflector 112 to sense the operating temperature T₂ of the light source reflector 112, for example. The predetermined temperature Tₛ is the ideal operating temperature of the light source reflector 112 when the lampwick 114 is operating at the ideal operating temperature of the lampwick. Since the light source module 100b and method of operation are identical to the aforementioned embodiment, detailed description thereof is omitted.

Similarly, the present invention is not limited to this embodiment. For example, the fan 120 is an axial fan, and the temperature sensor 130 (the thermal couple) is disposed on the lampwick 114 to sense the operating temperature T₁ of the lampwick 114. However, the predetermined temperature Tₛ is the ideal operating temperature of the lampwick 114.

In summary, the present invention uses the temperature sensor to sense the operating temperature of the light source unit and adjusts the rotation speed of the fan by using the temperature controller to compare the operating temperature with the ideal operating temperature of the light source unit. Therefore, the present invention controls the operating temperature of the light source unit closer to the ideal operating temperature of the light source unit and optimizes the brightness and life span of the light source unit at the same time.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light source module for a projection apparatus, comprising:
a light source unit;
a fan, disposed towards the light source unit for cooling the light source unit;
a temperature sensor, disposed adjacent to the light source unit for sensing an operating temperature of the light source unit; and
a temperature controller, electrically coupled to the fan and the temperature sensor, for adjusting a rotation speed of the fan according to the operating temperature.

2. The light source module according to claim 1, wherein the light source unit comprises a light source reflector and a lampwick disposed inside the light source reflector.

3. The light source module according to claim 2, wherein the fan is disposed towards the lampwick for cooling the lampwick.

4. The light source module according to claim 2, wherein the temperature sensor is a thermal couple disposed on the light source reflector for sensing a temperature of the light source reflector or disposed on the lampwick for sensing a temperature of the lampwick.

5. The light source module according to claim 2, wherein the temperature sensor is an infrared sensor disposed towards the light source reflector for sensing a temperature of the light source reflector or disposed towards the lampwick for sensing a temperature of the lampwick.

6. The light source module according to claim 2, wherein the temperature controller has a storage unit for saving a predetermined temperature of the light source unit.

7. The light source module according to claim 6, wherein the predetermined temperature is an ideal operating temperature of the lampwick.

8. The light source module according to claim 6, wherein the predetermined temperature is an ideal operating temperature of the light source reflector when the lampwick is operating at an ideal operating temperature of the lampwick.

9. The light source module according to claim 6, wherein the temperature controller further comprises a decision module for comparing the operating temperature with the predetermined temperature to adjust the rotation speed of the fan.

10. The light source module according to claim 9, wherein the temperature controller increases the rotation speed of the fan when the decision module determines that the operating temperature is higher than the predetermined temperature, and the temperature controller decreases the rotation speed of the fan when the decision module determines that the operating temperature is lower than the predetermined temperature.

11. The light source module according to claim 1, wherein the fan comprises an axial fan or a blower.

12. The light source module according to claim 1, wherein the temperature controller further comprises a voltage control unit for adjusting a voltage driving the fan to adjust the rotation speed of the fan.
